(19) United States
(12) Patent Application Publication
(10) Pub. No.: US 2004/0188394 A1
(43) Pub. Date: Sep. 30, 2004

(54) Process for laser welding with pre- and/or post-heating in the area of the weld seam

(76) Inventors: Wolfgang Becker, Ulm (DE); Markus Beck, Oberelchingen (DE); Klaus Goth, Sindelfingen (DE); Mike Paelmer, weil der Stadt (DE); Claus-Dieter Reiniger, Remshalden (DE); Daniel Zauner, Ballendorf (DE)

Correspondence Address: PENDORF & CUTLIFF, 5111 MEMORIAL HIGHWAY, TAMPA, FL, 33634-7356, US

(21) Appl. No.: 10/790,383

(22) Filed: Mar. 1, 2004

(30) Foreign Application Priority Data
Feb. 28, 2003 (DE) 103 09 158.0-11

(51) Int. Cl. B23K 26/20

(52) U.S. Cl. 219/121.64

(57) ABSTRACT

During welding of higher stiffness steels there is significant tendency towards hardening in the area of the weld seam, which introduces a loss in ductility and thus strongly reduces the durability and quality of the construction components.

For improving the seam quality an inductive pre or post warming of the weld seam has already been proposed. This requires a complex elaborate additional construction and provides a low flexibility with respect to the seam geometry. Beyond this the clamping of the construction component and changed requirements must be adapted to

The task of the present invention is comprised thus therein, to reduce the loss in ductility of the weld seam and thereby to reduce the necessary apparatus complexity and the processing time to at least maintain, preferably to reduce.

The task is solved by a process in which the welding and warming are carried out by a single laser beam with a substantial even output and focusing however with varying rates of advance.

### BACKGROUND OF THE INVENTION

1. Field of Invention

The invention concerns a process for laser welding with pre- and/or post-heating in the area of the weld seam according to the precharacterizing portion of Patent claim 1.

To meet high quality standards it is known to thermally treat welding seams. This particularly concerns higher strength steels. The term “higher strength steel” characterizes steels with a tensile strength of greater than 300 MPa. When welding this type of high strength or high stiffness steel in the area of the welding seam a significant reduction in hardness occurs, which is accompanied by a loss in ductility, therewith strongly reducing the durability and quality of the components.

2. Related Art of the Invention

As a remedy, an inductive pre- or post-heating of the weld seam has already been proposed (Brenner et al.; “Inductive Assisted Laser Beam Welding for Tear-Free Joining of Hardenable Steels”, DVS-Report, Volume 216 (2001), pages 289-297). This requires an elaborate additional setup and provides low flexibility with respect to the seam geometry. Beyond this, the clamping or setting of the component or part must be adapted to the changed requirements.

For other applications, namely for welding of coateded sheets, it has already been proposed to subdivide the energy beam into multiple partial beams using a special mirror and to allow these to run side-by-side over the coated sheets, in order to even out the out-gassing of the vaporized coatings between the sheets, see WO 00/66314 A1. This requires a highly elaborate apparatus and has, besides this, the disadvantage that the partial beams are predefined and fixed with respect to their focal length and position relative to each other.

Likewise, with regard to the welding of coated sheet metal it has already been proposed to use a laser beam initially focused for welding, and to then retrace the path with the same laser beam over the weld seam but this time defocused, in order to “heal” the layer evaporated in the seam area, see DE 69202224 T2. For this, in a first work phase a laser beam is oriented rigidly perpendicularly, is focused over the surface to be welded and is guided over the abutment or contact surface of the coated sheet metal to be welded, such that the sheets are welded to each other, wherein the coating along the weld seam evaporates. In a second work phase the same laser beam is defocused and returned along the weld seam to the beginning thereof. The defocusing is so selected, that the illuminated surface is clearly broader than the weld seam. The working speed is so adjusted, that the energy input is large enough to melt the layer on the illuminated areas to the sides of the weld seam, however not large enough to cause vaporization. The molten surface coating should then also flow over the coating-free weld seam, thereafter solidify and therewith “heal” the coating of the sheet metal.

This process can only operate when the weld seam is already significantly cooled below the vaporizing temperature of the coating before “healing” irradiation of the weld seam. Besides this, the methodology of the “return travel” along the weld seam results in a very uneven surface warming, since the thermal treatment occurs with constant power, and initially welding seam areas are being illuminated which shortly before were welded, so that they are still hot, and at the end the thermal treatment is performed on areas of the weld seam which are already cooled.

Besides this, in comparison to the welding temperature of the sheet metal, the vaporizing temperature of the coating sets a very low upper limit of the permissible energy input, which allows only a superficial warming of the laser beam facing sheet metal, not however a through-going, in-depth thermal treatment of the entire weld seam.

### SUMMARY OF THE INVENTION

The task of the present invention is thus concerned with the task of keeping the loss in ductility in the seam area as low as possible. This is particularly important in the case of high stiffness steels since here metallurgical notches, and the therewith associated tension transmission, have particularly negative repercussions. At the same time the necessary complexity of the apparatus is to be maintained as low as possible and the processing time is to be kept to a minimum, preferably diminished.

With regard to the process to be obtained, the invention is set forth in the characterizing part of Patent claim 1. The further claims concern advantageous embodiments and further developments of the inventive process (Patent claims 2 through 5).

The task, with regard to the process to be provided, is inventively solved thereby that:

the welding and pre- and/or post-warming in the area of the weld seam is carried out with a single laser beam and with a substantially constant output, wherein welding and thermal treatment are time separated in such a manner that the amount of energy introduced by the first radiation can be used in the second working phase. The temperature drop of the respective radiated surface from the time of the first radiation to the time of the subsequent radiation is less than 50%. In the thermal treatment, the laser energy input, with regard to the illuminated surface and the unit of time, are adjusted by defocusing of the laser beam and/or increasing the speed of advance in such a manner that the temperature of the present or future weld seam on the side opposite the laser beam is increased by at least 10° C.

The thermal treatment is carried out with short time separation either prior to (thermal pretreatment) or after (thermal post-treatment) the actual welding. The thermal treatment can occur in two ways:

A) The laser is guided with substantially the same output (as required for welding) and the same focusing, however increased rate of advance and in certain cases multiple times over the seam area to be thermally treated.

B) The laser is guided over the same area to be thermally treated with substantially the same output (as required for welding) however greater defocusing and, in certain cases, also slower.

Of course combinations of Type A and Type B can be employed.

By the thermal pre- or post-treatment the ductility loss is significantly reduced, in particular in the case of thermal pre- and post-treatment of the welding seam.

In comparison to DE 69202224 T2 (which is based on a different application purpose) first the waiting time is reduced, whereby the processing time is significantly shortened. Second, a deeper warming of the entire weld seam occurs, warming not being limited only to its surface. It is this which makes possible for the first time to keep the loss in ductility in the area of the seam low. Beyond this, in embodiment of Type A there can be dispensed with the continuous change between the focused and defocused laser beam as essential in DE 69202224 T2, and therewith it becomes possible to dispense also with the therefore necessary elaborate apparatus construction.

The essential advantage in comparison to WO 00/66314 A1 is comprised therein, that only one laser beam and therewith also only one optical device for laser beam guidance is necessary, whereby the apparatus complexity is reduced.

In a preferred embodiment of the inventive process the laser beam is directed to the surface by means of a scanner device. A scanner device is a particularly rapid and flexible beam deflection device, for example a mirror system (comprising at least a single- or multi-axial controllable pivotable mirror) or also an acoustic-optical modulator. In this deflection device a mechanically adjustable optical element can also be included, which enables a rapid change in the focal length of the laser beam (as for example in a 3D-scanner device).

The greatest advantage of this design of the inventive process, in comparison to that previously mentioned, is comprised therein, that the scanner device is moved evenly relative to the surface of a plate or sheet (for example by a multi-axial linkage arm robot) and thereby the position of the laser beam can be changed extremely rapidly in a predetermined working area below the scanner device by the mirror of the scanner device. Thereby it is possible to direct the laser beam for a short working time rapidly and in certain cases multiple times over a working line to be warmed and then to very rapidly move the laser beam back to its beginning point, in order to carry out a new but this time slower welding process. Thereafter the laser beam can anew be rapidly directed to the beginning of the working or processing line, which anew is traveled over rapidly and in certain cases multiple times and thereby is warmed. Thereby there are dispensed with both the elaborate equipment or fixtures for the optical guidance of a second laser beam—as required in WO 00/66314 A1—as well as the times necessary for the repositioning of the laser beam during which an exclusively robot guided laser beam must be conventionally switched off and/or defocused. Therewith a very high utilization or working efficiency of the laser system is made possible. In contrast thereto, in conventional systems laser beams are directed over the working lines via rigid lens systems. In order to begin a new welding seam, the laser beam must be guided to its point of origin, and for this the lens system must be moved relative to the component or part. During this time the laser must be switched off, in order to avoid unintended melting of the component part or sub-element. As a consequence thereof the design of the present invention requires only a fragment of the processing time compared to conventional systems, and requires less complicated equipment. Beyond this, as a result of the greater flexibility of the scanner device, it becomes possible to remain true to the intended path and to perform thermal treatment and welding of even complicated seam patterns, and this respectively with only a single clamping of the component part.

In a further advantageous embodiment of the inventive process the laser beam is focused during the thermal treatment in such a manner that its focus is located from 0 to 50 mm, preferably from 5 to 30 mm, in particular approximately 20 mm, above the upper surface of the laser beam facing plate. Thereby it is achieved that the irradiation footprint of the laser on the surface exceeds that of the radiation footprint while in focus, and is preferably at least twice as large, better yet 8 times as large.

Alternatively, or additionally thereto, a further widening of the working or treatment surface can be accomplished by movement of the illumination surface by means of minimal deflections of the laser beam (superimposing a transverse movement component upon the main advance direction; so-called beam spinning or beam waggling). The beam spinning can be employed in both process steps, or even only with one step, preferably the warming step.

Such a more spread-out warming more evenly distributes the melting of the sheet and brings about the formation of a more even weld seam.

In a further advantageous embodiment of the inventive process the first and second process steps occur alternatively in the manner of a step seam. That is, first a short processing line or segment of 3 to 40 mm length, preferably 15 mm, is passed over preferably multiple times with high rate of advance of the laser beam and thus is warmed and prepared for the welding step (thermal pre-treatment). Thereafter the laser beam is returned to the beginning of the working line and passes thereover anew, with a lowered advance speed for welding. Thereafter the process is repeated in a smaller separation (3 to 60 mm) in the direction of advance, and thereafter renewed displaced and repeated, so that with time a dashed weld seam is formed in the manner of a step seam.

Alternatively, first the weld step can occur and thereafter a thermal post-treatment, or also a three step process with thermal pre-treatment and thermal post-treatment.

The time between the first and second process steps is so small, that the sheet metal only slightly cools, and thus the laser beam need only be moved slightly slower during the second process step in order to introduce sufficient energy for melting and welding the sheet. In this manner there forms, in particular in combination with the described thermal post-treatment, a more even weld seam with significantly less reduction in tensile strength.

### DETAILED DESCRIPTION OF THE INVENTION

In the following the inventive process will be described in greater detail on the basis of three illustrative embodiments:

According to a first illustrative embodiment two high-strength steel sheets (as are conventionally employed in automobile construction) are placed on top of each other, a scanner device is moved evenly thereover and deflects a laser beam according to the above-described Process Type A, that is, with focusing remaining constant, sequentially over a series of processing lines. The scanner device is comprised of a two-dimensional pivotable computer controlled mirror system. The scanning device is located spaced approximately 300 mm from the upper surface of the first sheet. The focus (focal point) of the laser beam is on the surface of the first sheet during the first thermal pre-treatment (first process step).

Next, the laser beam is guided very rapidly (rate of advance approximately 15 m/min) and multiple times back and forth over a processing line of approximately 20 mm length. Therein a transverse movement component is superimposed over the main direction of movement; so-called beam spinning, so that an elongate spiral-shaped movement track is formed and widens the line of working. Thereby a broad-surfaced and even warming of the surface being processed occurs with outwardly continuously decreasing temperature gradients. These thermal pre-treatment takes approximately 300 ms. After a switch-over time of approximately 50 ms laser welding occurs along the warmed processing line with a slower rate of advance of approximately 5 m/min (second processing step). The welding takes approximately 250 ms. Also, during welding, the focus (focal point) is on the surface of the first sheet. The even thermal pre-treatment reduces the rate of cooling during welding, and therewith significantly reduces the ductility loss in the seam area. This can be proven by measuring the decrease in hardening and the increased dynamic load bearing ability of the weld seam.

The first processing line joins a second warming line as well as a second weld seam. These alternating process steps are carried out so that a dashed weld seam in the form of a step seam results.

In a second exemplary embodiment according to Process Type B, thermal treatment and welding occur with the laser beam being differently focused. For this, the scanner device of the preceding embodiment additionally has an optical element for adjusting the focal length. The focus (focal point) of the laser beam is approximately 20 mm above the surface of the first sheet during the thermal pre-treatment (first process step). The illumination surface or footprint is approximately 8 times larger than the illumination footprint when in focus.

Thermal treatment and welding occur analogously to the first illustrated embodiment. The surface specific energy density during thermal treatment is approximately 1/10 that of the welding value due to the defocusing, and as a consequence the rate of advance can be reduced to a corresponding value. The processing time for the travel over the surface for thermal treatment is thus higher. Since here only one passage over is necessary for the thermal treatment, the total processing time does not increase in comparison to the first illustrative embodiment. The transition time between thermal treatment and welding is increased, on the basis of the supplemental necessary change of the focusing, to 100 ms.

In a third illustrative embodiment the process is analogous to the first illustrated embodiment, however a third process step is supplementally introduced for thermal post-treatment. Thereby the temperature gradient of the processing line and the time required for reduction is further evened-out. The ductility loss in the seam area is further reduced.

In the embodiments of the above described examples the inventive process has proven itself as particularly suited for laser welding of high stiffness steel plates in the automobile industry. It can however be employed for the qualitative welding of other welding materials, and in particular other metals or also plastic can be employed.

In particular substantial improvements with regard to the seam quality, above all the ductility, can be achieved therewith; however, substantial improvements are also achieved with regard to the reduced elaborateness of the construction and reduced processing time.

The invention is not only limited to the above described illustrative embodiments, but rather can be applied more broadly.

Thus it is conceivable for example that the scanner device includes, in place of the mirror system, an acoustic-optical modulator. Further, it is possible that in place of guiding the laser scanner over the construction component surface, the construction components are moved below a spatially fixed scanner. In certain cases scanner and construction component can carry out a movement coordinated relative to each other.

1. Process for laser beam welding, with pre- and/or post-warming in the area of the weld seam,
wherein welding and thermal treatment are carried out by means of a single laser beam with substantially constant output,
thereby characterized,
that welding and thermal treatment are separated timewise from each other in such a manner that the temperature reduction of the respective illuminated surface from the point in time of the first illumination to the point of the subsequent illumination is less than 50%, and
that during the thermal treatment
the laser energy input, based on the illuminated surface area and time, is adjusted by defocusing the laser beam and/or increasing the rate of advance in such a manner that the side of the existing or to-be-formed weld seam opposite to the laser beam is warmed by at least 10° C.

2. Process according to claim 1, thereby characterized that the laser beam is guided on the surface via a scanner device.

3. Process according to one of the preceding claims, thereby characterized, that the laser beam during thermal treatment is defocused in such a manner that its focus is between 2 and 50 mm, preferably approximately 20 mm, from the surface of the laser beam facing side of the plate.

4. Process according to one of the preceding claims, thereby characterized, that during the thermal treatment the laser beam is guided in such a manner that a transverse, preferably circular, movement component is superimposed over its main direction of advance (so-called beam spinning).

5. Process according to one of the preceding claims, thereby characterized, that welding and warming occur alternatingly in the manner of a step seam.
